(19) United States
(12) Patent Application Publication
(10) Pub. No.: US 2018/0005113 A1
(43) Pub. Date: Jan. 4, 2018

(54) INFORMATION PROCESSING APPARATUS, NON-TRANSITORY COMPUTER-READABLE STORAGE MEDIUM, AND LEARNING-NETWORK LEARNING VALUE COMPUTING METHOD

(71) Applicant: FUJITSU LIMITED, Kawasaki-shi (JP)

(72) Inventor: Akihiko Kasagi, Kawasaki (JP)

(73) Assignee: FUJITSU LIMITED, Kawasaki-shi (JP)

(21) Appl. No.: 15/496,361

(22) Filed: Apr. 25, 2017

(30) Foreign Application Priority Data
Jun. 29, 2016 (JP) 2016-129309

(51) Int. Cl. G06N 3/08

(52) U.S. Cl. CPC G06N 3/08

(57) ABSTRACT

An information processing apparatus includes a pooling layer and a convolution layer. The pooling layer acquires, information on an error gradient including a plurality of elements from an upper layer. The convolution layer specifies, when computing a value of one element included in a weight gradient, an area corresponding to the one element among from a plurality of elements included information acquired from a lower layer, and divides the specified area having elements into a plurality of partial areas. The convolution layer computes, for each of the partial areas, a value based on one or more total values of the elements included in the one or more partial areas and a value of one of the elements of the error gradient corresponding to the corresponding partial area, and totalizes the computed values to execute a process for computing the value of the one element.

### CROSS-REFERENCE TO RELATED APPLICATION(S)

This application is based upon and claims the benefit of priority of the prior Japanese Patent Application No. 2016-129309, filed on Jun. 29, 2016, the entire contents of which are incorporated herein by reference.

### FIELD

The embodiments discussed herein are related to an information processing apparatus, a computer-readable storage medium, and a learning-network learning value computing method.

### BACKGROUND

A Convolutional Neural Network (CNN) is a multi-layer network that learns a subject of an image by using a convolution operation, and is constituted of layers whose processing contents differ from each other. FIGS. 21 and 22 are diagrams illustrating a conventional CNN. As illustrated in FIGS. 21 and 22, the CNN includes a convolution layer 10a, a fully connected layer 10b, and a sigmoid layer 10c.

The CNN reflects the difference between a correct answer and an answer of the network when images are input in order to perform learning of the network so that the correct answer can be universally derived. There exist two phases of normal and reverse propagations in learning of the network, and the normal and the reverse propagations are repeatedly performed.

A process of the normal propagation will be explained with reference to FIG. 21. In the normal propagation, images 1a, 2a, 3a, and 4a are input to the network, and probability vectors 1b, 2b, 3b, and 4b are computed for the respective images. A convolution operation is performed by using a kernel 5 in the convolution layer 10a of the network so as to extract the feature amounts from the input images 1a to 4a. The extracted feature amounts are converted into feature amount vectors by the fully connected layer 10b. The feature amount vectors are converted into the probability vectors 1b to 4b by the sigmoid layer 10c.

The probability vector 1b illustrated in FIG. 21 indicates that the probability of the image 1a being “0” is 100%. The probability vector 2b indicates that the probability of the image 2a being “1” is 100%. The probability vector 3b indicates that the probability of the image 3a being “3” is 100%. The probability vector 4b indicates that the probability of the image 4a being “2” is 100%.

A process of the reverse propagation will be explained with reference to FIG. 22. In the reverse propagation, an error gradient between the correct answer and the probability vectors 1b to 4b output by the normal propagation of the network is computed, and the error gradient is propagated in the network in reverse order to the normal propagation. Each of the convolution layer 10a, the fully connected layer 10b, and the sigmoid layer 10c computes the error gradient to be sent to the next layer thereof in the reverse direction, and further computes a weight gradient based on a correct weight such that the corresponding layer gets the correct answer.

Next, a part in the CNN will be focused on, in which the convolution layer and the pooling layer that performs Average-pooling are sequenced. Although explanation thereof is omitted in FIGS. 21 and 22, the pooling layer is a layer that exists between the convolution layer 10a and the fully connected layer 10b. FIG. 23 is a diagram illustrating a process example of conventional pooling and convolution layers. Data1 illustrated in FIG. 23 is data that corresponds to the images 1a to 4a illustrated in FIG. 21. An error gradient diff1 is an error gradient that is output from the convolution layer 10a.

A weight w_data2 is a weight that is used in the convolution layer 10a, and corresponds to the kernel. In the normal propagation process, the convolution layer 10a performs computation of convolution by using the weight w_data2 to convert the data data1 into data data2, and outputs the converted data data2 to the pooling layer 10d.

On the other hand, in the reverse propagation process, the convolution layer 10a acquires an error gradient diff2 from the pooling layer 10d, and computes a weight gradient w_diff2 on the basis of the error gradient diff2. The convolution layer 10a updates the weight w_data2 by using a value obtained by subtracting the weight gradient w_diff2 from the weight w_data2. The convolution layer 10a computes the error gradient diff1 on the basis of the error gradient diff2 and the weight gradient w_diff2, and outputs the error gradient diff1 to the lower layer.

In the normal propagation process, the pooling layer 10d performs Average-pooling on the data data2 to generate data data3. An error gradient diff3 is an error gradient that is acquired by the pooling layer 10d from the upper layer in the reverse propagation process. The pooling layer 10d converts the error gradient diff3 into the error gradient diff2, and outputs the converted error gradient diff2 to the convolution layer 10a. These related-art example are described, for example, in Japanese Laid-open Patent Publication No. 2015-210672, Japanese Laid-open Patent Publication No. 2008-310524, and Japanese Laid-open Patent Publication No. 2015-052832

However, in the aforementioned conventional technology, there exists a problem that an operation amount in the convolution layer is large.

### SUMMARY

According to an aspect of an embodiment, an information processing apparatus includes a processor that executes a process including acquiring, in a pooling layer, information on an error gradient including a plurality of elements from an upper layer, when computing a learning value of a learning network including a plurality of layers; performing, in a convolution layer, cumulative additions on a plurality of elements included in the information in a lateral direction and a longitudinal direction to convert the information into an integrated image, when acquiring information from a lower layer; specifying, in the convolution layer, an area corresponding to the one element among from a plurality of elements included in the integrated image, when computing a value of one element included in a weight gradient; dividing, in the convolution layer, the specified area having elements into a plurality of partial areas; first computing, in the convolution layer, total values of elements included in the respective partial areas based on characteristics of the integrated image; second computing, in the convolution layer, for each of the partial areas, a value based on the one or more total values of the elements included in the one or more partial areas and a value of one of the elements of the error gradient corresponding to the corresponding partial area; and totalizing, in the convolution layer, the computed values to execute a process for computing the value of the one element.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1 and 2 are diagrams illustrating one example of processes for computing a weight gradient w_diff2 executed by a conventional Convolutional Neural Network (CNN);

FIG. 3 is a flowchart illustrating a processing procedure for computing the weight gradient w_diff2 executed by the conventional CNN;

FIG. 4 is a functional block diagram illustrating a configuration of an information processing apparatus according to a first embodiment;

FIG. 5 is a diagram illustrating a process of a convolution layer according to the first embodiment;

FIG. 6 is a diagram illustrating one example of a process for converting input data into an integrated image;

FIG. 7 is a diagram illustrating one example of a process for computing a sum of a rectangular area by using the integrated image;

FIG. 8 is a diagram illustrating a process of the convolution layer using characteristics of the integrated image;

FIG. 9 is a flowchart illustrating a processing procedure of the information processing apparatus according to the first embodiment;

FIG. 10 is a diagram illustrating computation amounts for deriving the weight gradient w_diff2;

FIG. 11 is a diagram illustrating one example of a process for computing an error gradient executed by the conventional CNN;

FIG. 12 is a diagram illustrating a processing procedure for computing an error gradient diff2 executed by the conventional CNN;

FIG. 13 is a functional block diagram illustrating a configuration of an information processing apparatus according to a second embodiment;

FIGS. 14 and 15 are diagrams illustrating processes of a convolution layer according to the second embodiment;

FIG. 16 is a diagram illustrating a rectangular difference table;

FIG. 17 is a diagram illustrating one example of the rectangular difference table generated by the convolution layer according to the second embodiment;

FIG. 18 is a flowchart illustrating a processing procedure of the information processing apparatus according to the second embodiment;

FIG. 19 is a diagram illustrating computation amounts for deriving an error gradient diff1;

FIG. 20 is a diagram illustrating a hardware configuration example of the information processing apparatus;

FIGS. 21 and 22 are diagrams illustrating the conventional CNN; and

FIG. 23 is a diagram illustrating a process example of conventional pooling and convolution layers.

### DESCRIPTION OF EMBODIMENTS

Preferred embodiments of the present invention will be explained with reference to accompanying drawings.

The disclosed technology is not limited to the embodiments described below.

### [a] First Embodiment

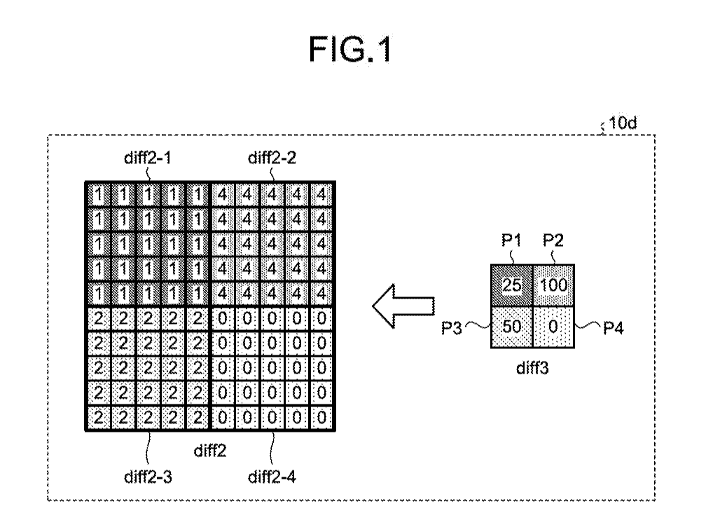

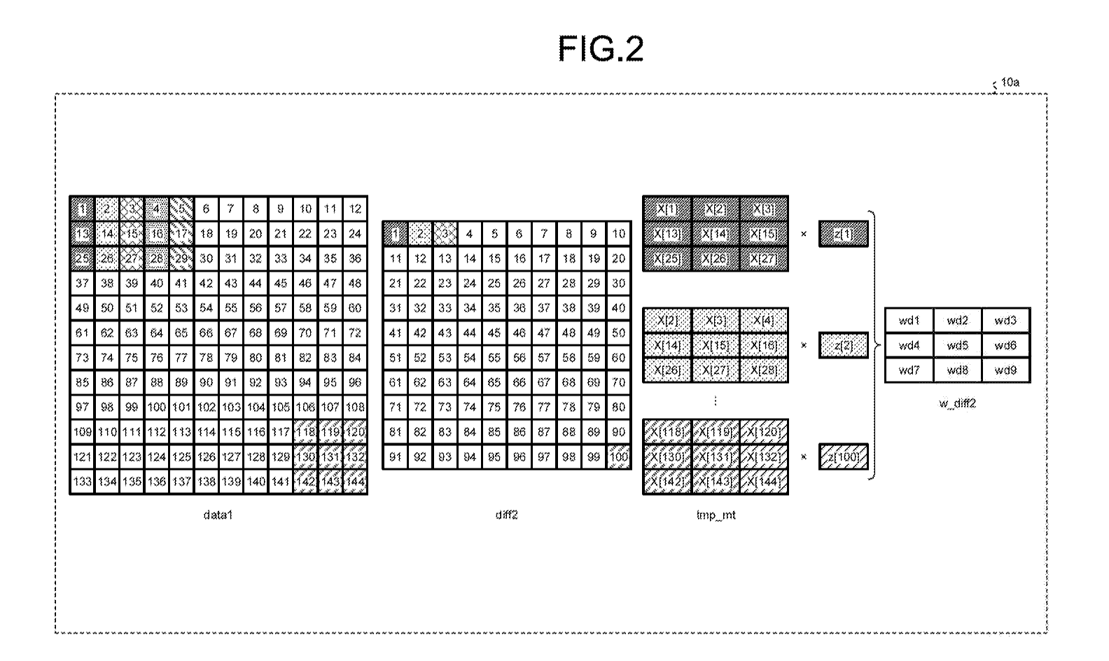

Before starting the explanation of a first embodiment, one example of a process for computing a weight gradient w_diff2 executed by a Convolutional Neural Network (CNN) will be explained. FIGS. 1 and 2 are diagrams illustrating one example the process for computing the weight gradient w_diff2 executed by the conventional CNN. As illustrated in FIG. 1, when acquiring an error gradient diff3 from the upper layer, the pooling layer 10d averagely expands the error gradient diff3 to generate an error gradient diff2.

In the example illustrated in FIG. 1, the error gradient diff3 (2×2) is given, and the pooling layer 10d expands the error gradient diff3 to obtain the error gradient diff2 (10×10). Let elements of the error gradient diff3 be P1, P2, P3, and P4. The pooling layer 10d expands the elements P1, P2, P3, and P4 to obtain respective diff2-1, diff2-2, diff2-3, and diff2-4 that constitutes 5×5 areas. In Average-pooling of the reverse propagation, values, which are obtained by dividing values of the elements P1, P2, P3, and P4 by 25, are stored in the respective areas diff2-1, diff2-2, diff2-3, and diff2-4.

Going into the explanation of FIG. 2, numerical values illustrated in the data data1 and the error gradient diff2 are indexes. The convolution layer 10a segments the data data1 for each kernel size to perform scalar multiplication thereon by using the corresponding value of the error gradient diff2. In the example illustrated in FIG. 2, the kernel size is assumed to be 3×3. Herein, “tmp_mt” indicates a matrix. “X[i]” included in the matrices tmp_mt indicates a value corresponding to an index i in the data data1, and “z[i]” indicates a value corresponding to the index i of data data2.

For example, the convolution layer 10a computes values of elements wd1 to wd9 included in the weight gradient w_diff2 as follows.

wd1=X[1]×z[1]+X[2]×z[2]+ . . . +X[118]×z[100]

wd2=X[2]×z[1]+X[3]×z[2]+ . . . +X[119]×z[100]

wd3=X[3]×z[1]+X[4]×z[2]+ . . . +X[120]×z[100]

wd4=X[13]×z[1]+X[14]×z[2]+ . . . +X[130]×z[100]

wd5=X[14]×z[1]+X[15]×z[2]+ . . . +X[131]×z[100]

wd6=X[15]×z[1]+X[16]×z[2]+ . . . +X[132]×z[100]

wd7=X[25]×z[1]+X[26]×z[2]+ . . . +X[118]×z[100]

wd8=X[26]×z[1]+X[27]×z[2]+ . . . +X[143]×z[100]

wd9=X[27]×z[1]+X[28]×z[2]+ . . . +X[144]×z[100]

In the example illustrated in FIG. 2, “100” 3×3 matrices tmp_mt are generated. The conventional convolution layer 10a performs scalar multiplication on the 100 matrices tmp_mt, and then totalizes them to compute the weight gradient w_diff2.

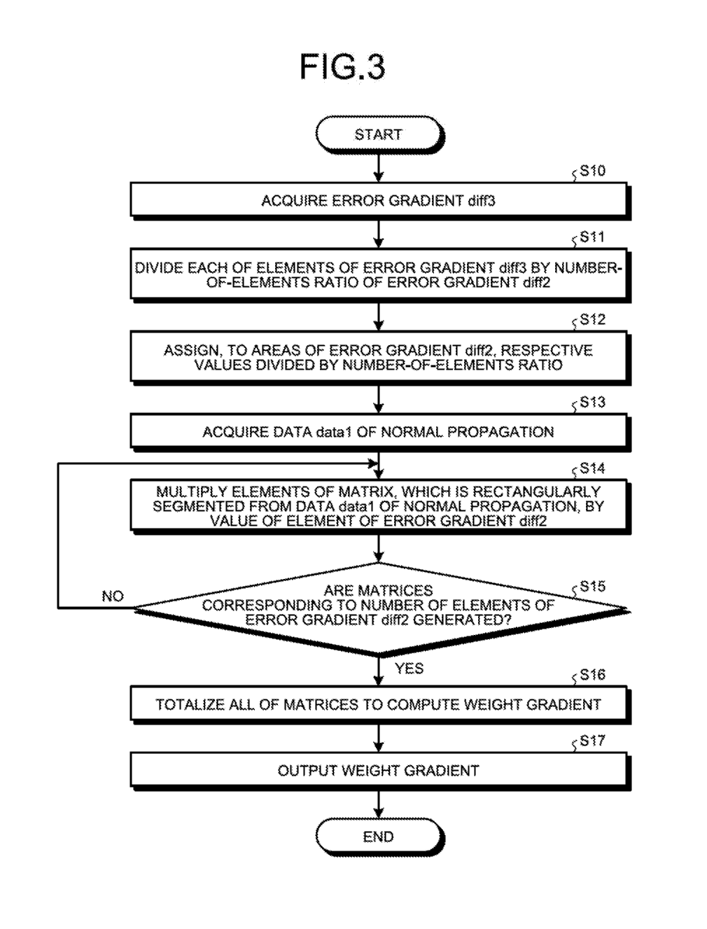

Next, one example of a processing procedure for computing the weight gradient w_diff2 executed by the conventional CNN will be explained. FIG. 3 is a flowchart illustrating a processing procedure for computing the weight gradient w_diff2 executed by the conventional CNN. As illustrated in FIG. 3, the pooling layer 10d of the CNN acquires the error gradient diff3 (Step S10). The pooling layer 10d divides each of the elements of the error gradient diff3 by a number-of-elements ratio of the error gradient diff2 (Step S11). The pooling layer 10d assigns, to the areas of the error gradient diff2, the respective values divided by the number-of-elements ratio (Step S12).

The convolution layer 10a of the CNN acquires the data data1 of the normal propagation (Step S13). The convolution layer 10a multiplies the elements X[i] in the matrix tmp_mt, which is rectangularly segmented from the data data1 of the normal propagation, by the element (z[i]) of the error gradient diff2 (Step S14). The convolution layer 10a determines whether or not the matrices tmp_mt corresponding to the number of the elements of the error gradient diff2 are generated (Step S15).

When the matrices tmp_mt corresponding to the number of the elements of the error gradient diff2 are not generated (Step S15: No), the process is shifted to Step S14. On the other hand, when the matrices tmp_mt corresponding to the number of the elements of the error gradient diff2 are generated (Step S15: Yes), the convolution layer 10a totalizes all of the matrices tmp_mt to compute the weight gradient w_diff2 (Step S16). The convolution layer 10a outputs the weight gradient w_diff2 (Step S17).

In the process in which the conventional CNN computes the weight gradient w_diff2, the operation amount of, for example, Steps S13 to S16 illustrated in FIG. 3 is large.

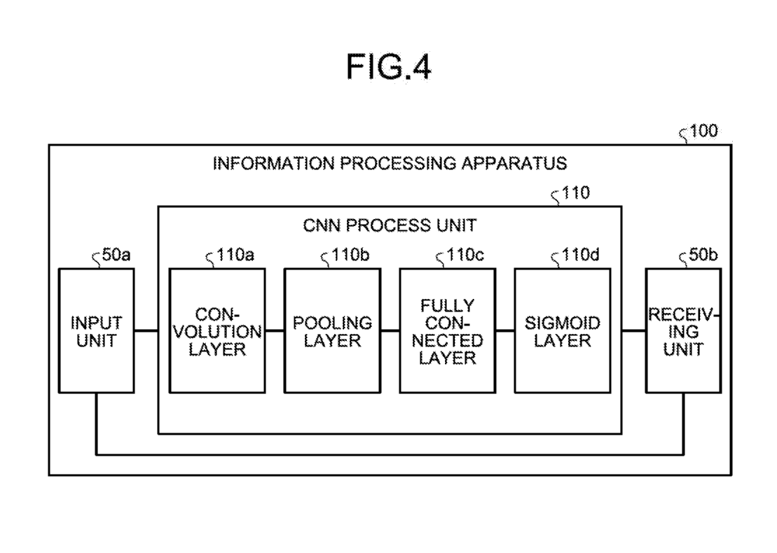

Next, a configuration of an information processing apparatus according to the first embodiment will be explained. FIG. 4 is a functional block diagram illustrating the configuration of the information processing apparatus according to the first embodiment. As illustrated in FIG. 4, this information processing apparatus 100 includes an input unit 50a, a receiving unit 50b, and a CNN process unit 110.

The input unit 50a is a processing unit that inputs the image data to be learned into the CNN process unit 110. The input unit 50a outputs, to the receiving unit 50b, correct answer information on the probability vectors for the input image data.

The receiving unit 50b is a processing unit that receives, from the CNN process unit 110, the information on the probability vectors for the image data input by the input unit 50a. The receiving unit 50b computes the difference between the probability vectors received from the CNN process unit 110 and the correct answer information so as to obtain the error gradient, and outputs information on the error gradient to the CNN process unit 110.

The CNN process unit 110 is a processing unit that reflects the error gradient between the correct answer information and the answer of the network when the image data is input in order to perform the learning of the network so that the correct answer can be universally obtained. The CNN process unit 110 includes a convolution layer 110a, a pooling layer 110b, a fully connected layer 110c, and a sigmoid layer 110d. The CNN process unit 110 may correspond to an integrated device such as an Application Specific Integrated Circuit (ASIC) and a Field Programmable Gate Array (FPGA). The CNN process unit 110 may correspond to an electronic circuit such as a Central Processing Unit (CPU) and a Micro Processing Unit (MPU).

In the learning of the network performed by the CNN process unit 110, there exists two phases of the normal and the reverse propagations, and the normal and reverse propagations are repeatedly executed.

A process of the normal propagation to be executed by the CNN process unit 110 will be explained. When receiving an input of the image data in the normal propagation, the CNN process unit 110 performs a convolution operation by using the kernels in the convolution layer 110a, and extracts feature amounts from the input image data. Average-pooling is executed on the extracted feature amounts by the pooling layer 110b, and then is input to the fully connected layer 110c. The fully connected layer 110c converts the feature amounts into the feature amount vectors. The feature amount vectors are converted into the probability vectors by the sigmoid layer 110d.

A process in the reverse propagation to be executed by the CNN process unit 110 will be explained. The CNN process unit 110 acquires, from the receiving unit 50b, information on the error gradient between the probability vectors and the correct answer information, and propagates the error gradient in the network in reverse to the normal propagation. Each of the convolution layer 110a, the fully connected layer 110c, and the sigmoid layer 110d computes the corresponding error gradient to be sent to the next layer thereof in the reverse direction, and further computes the corresponding weight gradient using the correct weight such that the corresponding layer obtains the correct answer.

Herein, because a method of the CNN process unit 110 according to the first embodiment for computing the weight gradient w_diff2 in the convolution layer 110a differs from that of the conventional CNN, the process for computing the weight gradient w_diff2 executed by the convolution layer 110a will be explained.

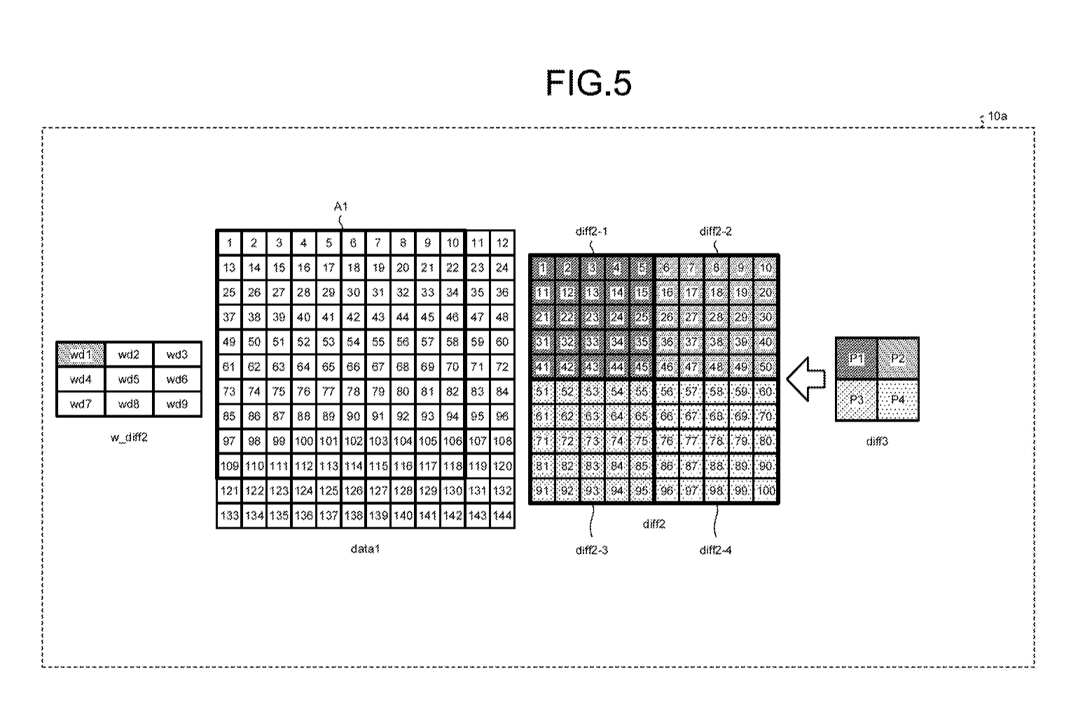

FIG. 5 is a diagram illustrating the process of the convolution layer according to the first embodiment. Numerical values of the data data1 and the error gradient diff2 illustrated in FIG. 5 are indexes. The error gradient diff3 illustrated in FIG. 5 is an error gradient that is acquired by the pooling layer 110b from the upper layer. The pooling layer 110b expands the error gradient diff3 to obtain the error gradient diff2 (10×10) similarly to the pooling layer 10d illustrated in FIG. 1. For example, the pooling layer 110b expands the elements P1, P2, P3, and P4 to obtain respective diff2-1, diff2-2, diff2-3, and diff2-4 that are 5×5 areas. In Average-pooling of the reverse propagation, values, which are obtained by dividing values of the elements P1, P2, P3, and P4 by 25, are stored in the respective areas diff2-1, diff2-2, diff2-3, and diff2-4. When each size of the areas diff2-1, diff2-2, diff2-3, and diff2-4 is “n×n”, the pooling layer 110b stores values, which are obtained by dividing values of the elements P1, P2, P3, and P4 by “n×n”, in the respective areas diff2-1, diff2-2, diff2-3, and diff2-4.

Herein, a computation example of the element wd1 included in the weight gradient w_diff2 will be considered. The value of the element wd1 is computed by using a formula (1).

wd1=data1[1]×diff2[1]+data1[2]×diff2[2]+ . . . +data1[117]×diff2[99]+data1[118]×diff2[100] (1)

Herein, all of the values included in each of the areas diff2-1, diff2-2, diff2-3, and diff2-4 are found to be the same. Therefore, the aforementioned formula (1) can be changed into the following formula (2).

wd1=P1/25×sum(data1[1],data1[53])+P2/25×sum(data1[6],data1[58])+P3/25×sum(data1[61],data1[113])+P4/25×sum(data1[66],data1[118]) (2)

In the formula (2), sum(a, b) means a sum of values in a rectangular area decided by “a” and “b”. For example, sum(data1[1], data1[53]) corresponds to a value obtained by totalizing values of the indexes 1 to 5, 13 to 17, 25 to 29, 37 to 41, and 49 to 53 in the data data1.

In other words, the convolution layer 110a converts the computation indicated in the formula (1) into the computation indicated in the formula (2) of obtaining a sum of a rectangular area. For example, when computing the value of the element wd1 included in the weight gradient w_diff2, the convolution layer 110a specifies a computation range A1 on the data data1 corresponding to the element wd1. The convolution layer 110a divides the computation range A1 into rectangular areas whose number corresponds to that of the elements of the error gradient diff3. The convolution layer 110a multiplies a total value of the values included in each of the divided rectangular areas by the value corresponding to the corresponding element of the error gradient diff3, and totalizes the multiplied results to compute the value of the element wd1.

Similarly, when computing a value of an element wdi, the convolution layer 110a specifies a computation range Ai on the data data1 corresponding to an element wdi. The convolution layer 110a divides the computation range Ai into rectangular areas whose number corresponds to that of the elements of the error gradient diff3. The convolution layer 110a multiplies a total value of the values included in each of the divided rectangular areas by the value corresponding to the corresponding element of the error gradient diff3, and totalizes the multiplied results to compute the value of the element wdi.

When acquiring the data data1 from the lower layer, the convolution layer 110a converts the data data1 into an integrated image. As described below, the convolution layer 110a can reduce a process load when the weight gradient w_diff2 is computed by using the integrated image. First, one example of a process for converting data into an integrated image will be explained, and then a process for computing the weight gradient w_diff2 using the integrated image will be explained.

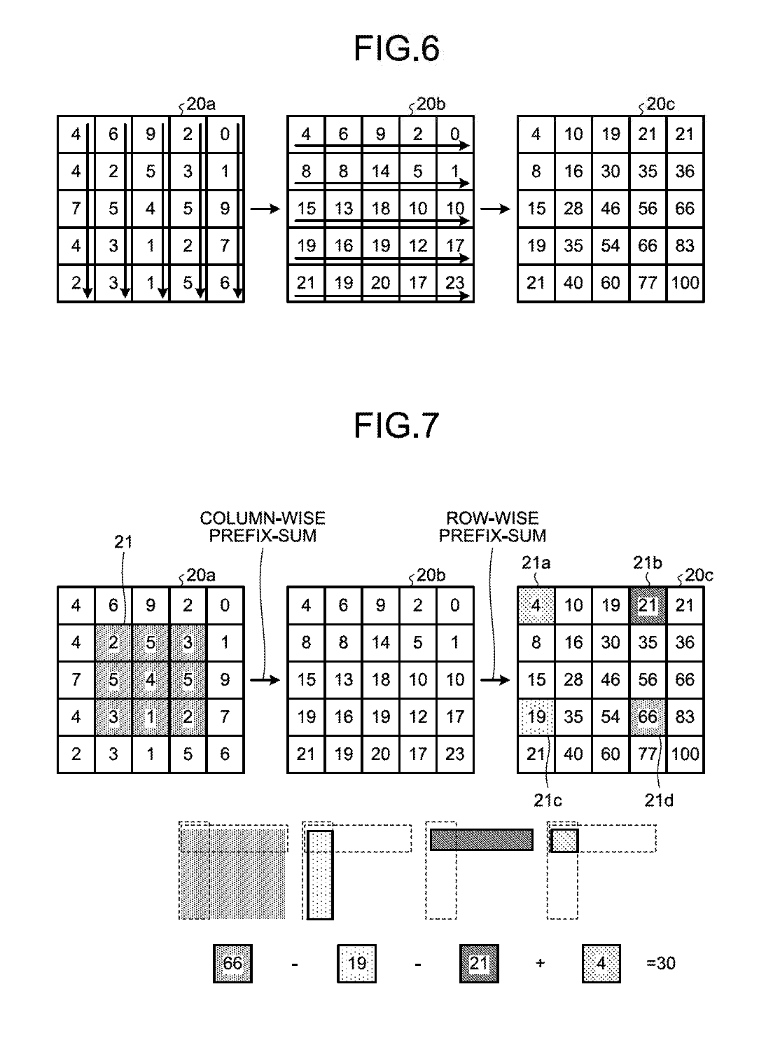

FIG. 6 is a diagram illustrating one example of the process for converting the input data into the integrated image. Herein, for convenience of explanation, let input data to be converted be data 20a. As described below, sequential execution of Column-wise prefix-sum and Row-wise prefix-sum generates an integrated image 20c corresponding to the data 20a.

The convolution layer 110a executes Column-wise prefix-sum on the data 20a with respect to a column direction thereof. Column-wise prefix-sum sequentially sums a value of a target cell and a value of a cell next above the target cell from a cell in the second row toward the lower cells therefrom. The convolution layer 110a executes Column-wise prefix-sum on the data 20a to generate data 20b.

Subsequently, the convolution layer 110a performs Row-wise prefix-sum on the data 20b with respect to a row direction thereof. Row-wise prefix-sum sequentially sums a value of a target cell and a value of a cell next left of the target cell from a cell in the second column toward the right cells therefrom. The convolution layer 110a performs Row-wise prefix-sum on the data 20b to generate the integrated image 20c.

When the integrated image is used, a sum of an arbitrary rectangular area can be easily computed. FIG. 7 is a diagram illustrating one example of a process for computing a sum of a rectangular area by using an integrated image. For example, the sum of a rectangular area 21 of the data 20a can be obtained by computing in the following manner.

“sum of rectangular area 21”=“value (66) of cell 21d”−“value (19) of cell 21c”−“value (21) of cell 21b”+“value (4) of cell 21a”=30

When acquiring the data data1 from the lower layer, the convolution layer 110a performs the aforementioned Column-wise prefix-sum and Row-wise prefix-sum to generate an integrated image of the data data1. Hereinafter, data of the integrated image of the data data1 may be referred to “data data1(SAT)”.

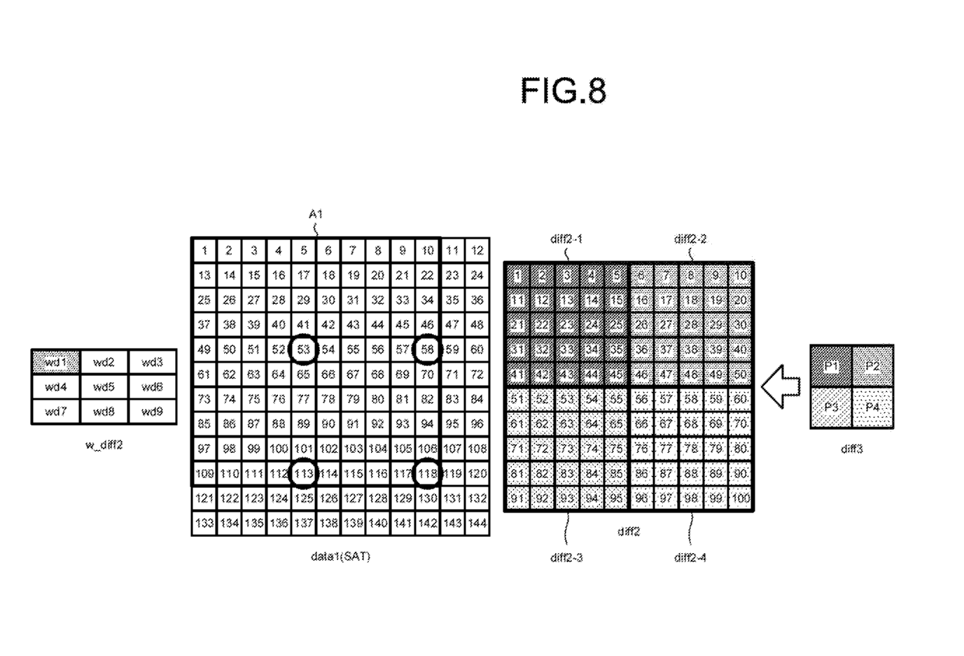

The formula (2) can be converted into a formula (3) by using characteristics of the aforementioned integrated image. FIG. 8 is a diagram illustrating a process of the convolution layer using characteristics of the integrated image. SAT[i] in the formula (3) indicates a total value of values included in a rectangular area, in which the index 1 is the upper-left end of the rectangular area and the index i is the lower-right end of the rectangular area, in the data data1 before the conversion into the integrated image.

wd1=P1/25×SAT[53]+P2/25×(SAT[58]−SAT[53])+P3/25×(SAT[113]−SAT[53])+P4/25×(SAT[118]−SAT[113]−SAT[58]+SAT[53]) (3)

Herein, for the convenience of explanation, the case in which a value of the element wd1 is computed, values of the elements wd2 to wd9 can be computed similarly thereto by using the characteristics of the integrated image.

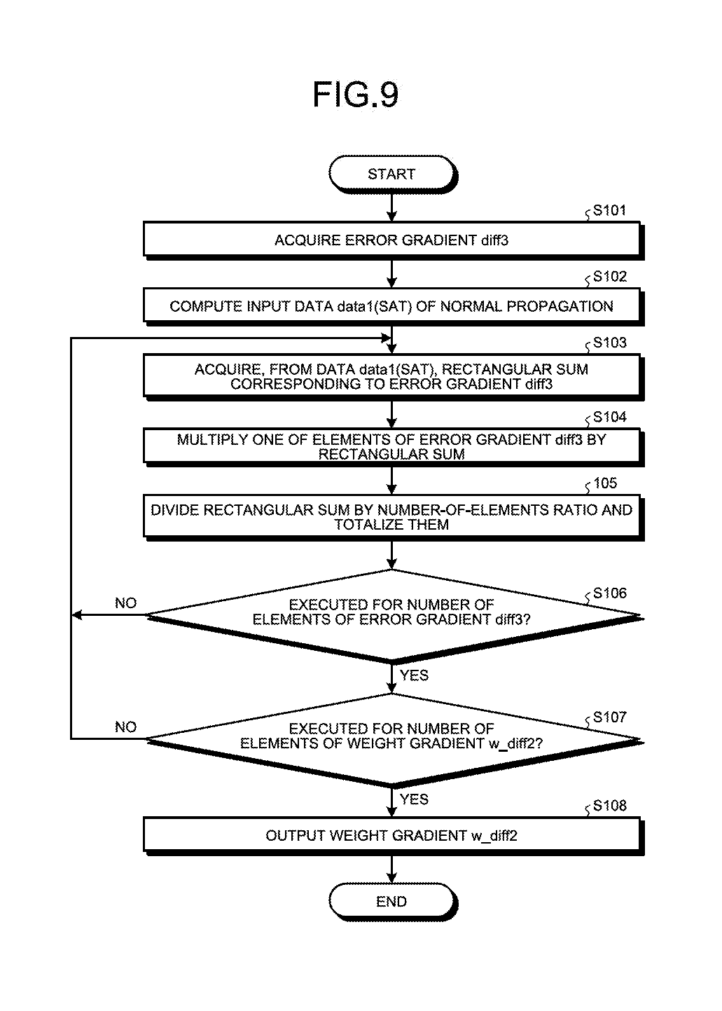

Next, a processing procedure of the information processing apparatus according to the first embodiment will be explained. FIG. 9 is a flowchart illustrating the processing procedure of the information processing apparatus according to the first embodiment. As illustrated in FIG. 9, the convolution layer 110a of the information processing apparatus 100 acquires the error gradient diff3 from the pooling layer 110b (Step S101). The convolution layer 110a computes the data data1(SAT) of the normal propagation (Step S102).

The convolution layer 110a acquires, from the data data1(SAT), a rectangular sum corresponding to the error gradient diff3 (Step S103). The convolution layer 110a multiplies one of the elements of the error gradient diff3 by the rectangular sum (Step S104). The convolution layer 110a divides the rectangular sum by the number-of-elements ratio, and totalizes them (Step S105). The convolution layer 110a determines whether or not, for example, Steps 103 to 105 are executed for the number of the elements of the error gradient diff3 (Step S106). When, for example, Steps 103 to 105 are not executed for the number of the elements of the error gradient diff3 (Step S106: No), the convolution layer 110a shifts the process to Step S103.

On the other hand, when, for example, Steps 103 to 105 are executed for the number of the elements of the error gradient diff3 (Step S106: Yes), the convolution layer 110a determines whether or not, for example, Steps 103 to 106 are executed for the number of the elements of the weight gradient w_diff2 (Step S107). When, for example, Steps 103 to 106 are not executed for the number of the elements of the weight gradient w_diff2 (Step S107: No), the convolution layer 110a shifts the process to Step S103.

On the other hand, when, for example, Steps 103 to 106 are executed for the number of the elements of the weight gradient w_diff2 (Step S107: Yes), the convolution layer 110a outputs the weight gradient w_diff2 (Step S108).

Next, effects of the information processing apparatus 100 according to the first embodiment will be explained. When computing the weight gradient w_diff2 in the process of the reverse propagation, the convolution layer 110a of the information processing apparatus 100 replaces the conventional computation with the computation of deriving sums of the rectangular areas of the data data1, so that it is possible to reduce the operation amount.

Herein, the conventional computation is a computation in which the data data1 is segmented by a kernel size to perform scalar multiplication thereon by using the corresponding value of the error gradient diff2, and totalizes the values of the matrices. On the other hand, the convolution layer 110a specifies a computation range on the data data1 corresponding to the elements of the weight gradient w_diff2, and divides the computation range into the rectangular areas whose number is according to that of the elements of the error gradient diff3. The convolution layer 110a multiplies each of the sums of the values included in the respective divided rectangular areas by the value corresponding to the element of the error gradient diff3, and totalizes the multiplied results to compute the values of the elements in the weight gradient w_diff2.

When computing the sum of the values included in each of the divided rectangular areas, the convolution layer 110a computes the sum of the divided rectangular area by using the characteristics of the integrated image, and thus the operation amount can be more reduced.

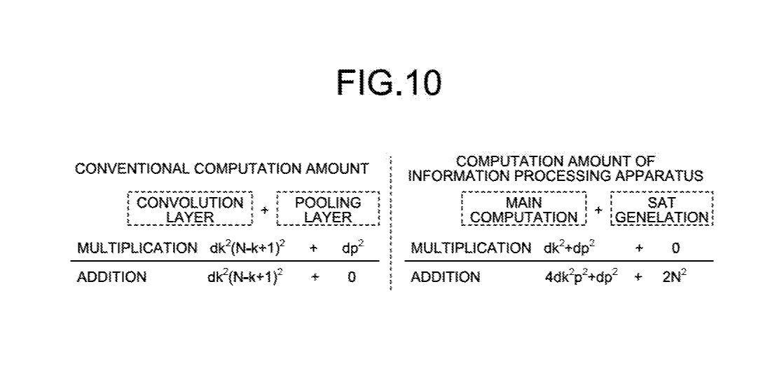

FIG. 10 is a diagram illustrating computation amounts for deriving the weight gradient w_diff2. The computation amount of the conventional technology is “dk²(N−k+1)²+dp²” with respect to the multiplication part, and is “dk² (N−k+1)²” with respect to the addition part. On the other hand, the computation amount of the information processing apparatus 100 according to the first embodiment is “dk²+dp²” with respect to the multiplication part, and is “4dk²p²+dp²+2N²” with respect to the addition part. Herein, let the size of the data data1 be “N×N”, the size of the weight gradient w_diff2 be “k×k”, the size of the error gradient diff3 be “p×p”, and the number of the kernels be “d”. The large/small relation between the symbols is “N>>p and N>>k”. For this reason, an influence to be given to the computation amount by the value “N” is large, and thus it is found that the computation amount of the conventional technology is larger than that of the information processing apparatus 100.

### [b] Second Embodiment

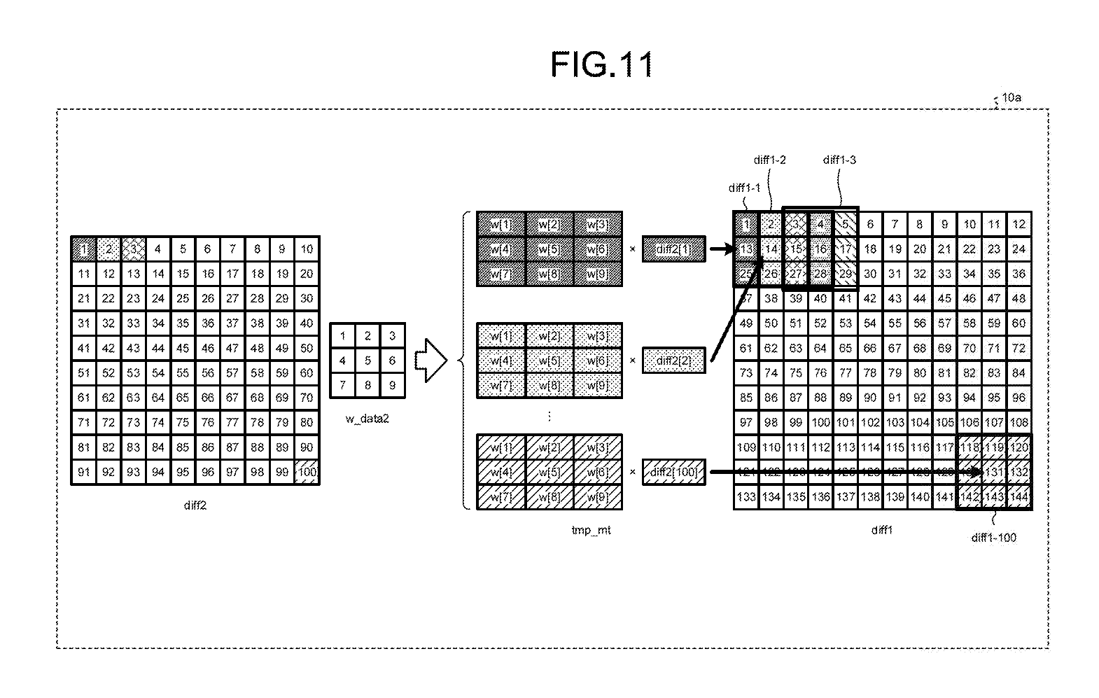

One example of a process for computing an error gradient diff1 executed by the conventional CNN will be explained before explaining a second embodiment. FIG. 11 is a diagram illustrating one example of the process for computing the error gradient executed by the conventional CNN. As illustrated in FIG. 1, when acquiring the error gradient diff3 from the upper layer, the pooling layer 10d of the conventional CNN averagely expands the error gradient diff3 to generate the error gradient diff2.

Numerical values of the error gradient diff2 and the weight gradient w_diff2 illustrated in FIG. 11 are indexes. Herein, w[i] included in the matrices tmp_mt indicates the value corresponding to the index i of the weight gradient w_diff2, and diff2[i] indicates the value corresponding to the index i of the error gradient diff2.

There exist elements of indexes 1 to 100 in the error gradient diff2, and thus the convolution layer 10a performs scalar multiplication on the weight gradient w_diff2 by using each of the elements in the error gradient diff2 so as to generate “100” 3×3 matrices tmp_mt. The convolution layer 10a executes a process for adding each of the “100” 3×3 matrices tmp_mt to the corresponding area of the error gradient diff1.

Each of the initial index values in the error gradient diff1 is zero. The convolution layer 10a updates the index values of the area diff1-1 by using the respective values obtained by adding the values of the weight (kernel) w_data2 multiplied by the value diff2[1] to the index values of the area diff1-1. For example, the convolution layer 10a updates the value of an index 1 in the area diff1-1 by using the value obtained by adding the value of “w[1]×diff2[1]” to a value of the index 1 of the area diff1-1. The convolution layer 10a updates the value of an index 2 in the area diff1-1 by using the value obtained by adding the value of “w[2]×diff2[1]” to the value of the index 2 of the area diff1-1. The convolution layer 10a similarly updates the other values of the indexes 3, 13, 14, 15, 25, 26, and 27 of the area diff1-1.

The convolution layer 10a updates the index values of the area diff1-2 by using the respective values obtained by adding the values of the weight (kernel) w_data2 multiplied by the value diff2[2] to the index values of the area diff1-2. As described above, the convolution layer 10a moves a target area of the error gradient diff1 while changing “w_data2×diff2[i]” to repeatedly execute the aforementioned process, and thus updates the index values of the error gradient diff1 to generate the final error gradient diff1.

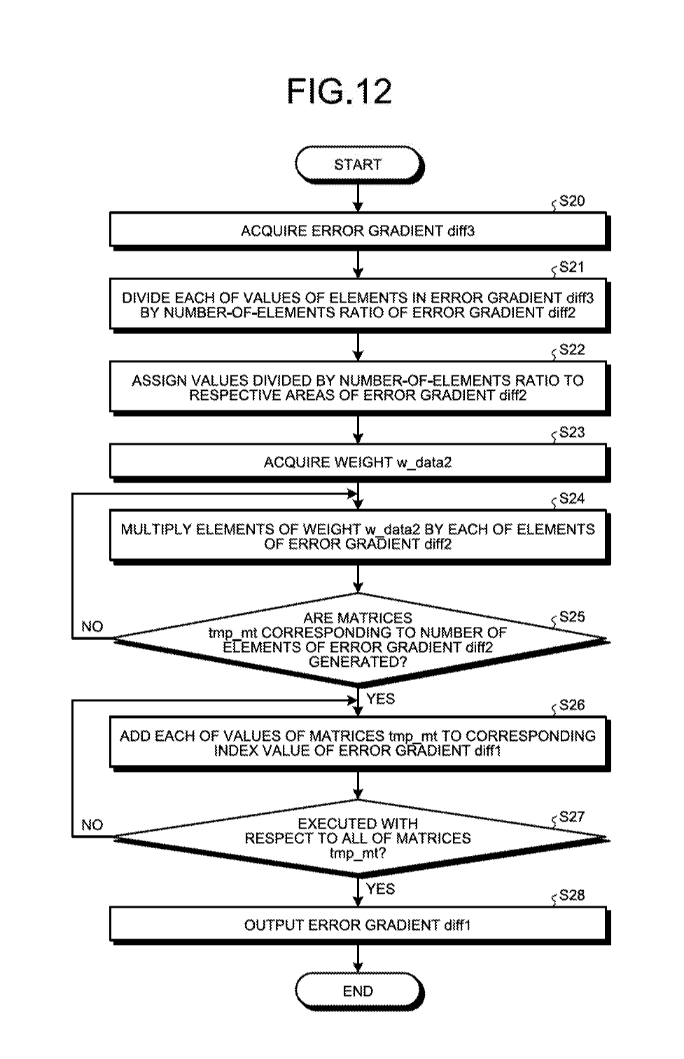

Next, one example of a processing procedure for computing the error gradient diff1 executed by the conventional CNN will be explained. FIG. 12 is a diagram illustrating the processing procedure for computing the error gradient diff2 executed by the conventional CNN. As illustrated in FIG. 12, the pooling layer 10d of the CNN acquires the error gradient diff3 (Step S20). The pooling layer 10d divides each of the values of the elements in the error gradient diff3 by the number-of-elements ratio of the error gradient diff2 (Step S21). The pooling layer 10d assigns the values divided by the number-of-elements ratio to the respective areas of the error gradient diff2 (Step S22).

The convolution layer 10a of the CNN acquires the weight (kernel) w_data2 (Step S23). The convolution layer 10a multiplies the elements of the weight w_data2 by each of the elements of the error gradient diff2 (Step S24). The convolution layer 10a determines whether or not the matrices tmp_mt corresponding to the number of the elements of the error gradient diff2 are generated (Step S25). When the matrices tmp_mt corresponding to the number of the elements of the error gradient diff2 are not generated (Step S25: No), the convolution layer 10a shifts the process to Step S24.

When the matrices tmp_mt corresponding to the number of the elements of the error gradient diff2 are generated (Step S25: Yes), the convolution layer 10a adds each of the values of the matrices tmp_mt to the corresponding index value of the error gradient diff1 (Step S26). The convolution layer 10a determines whether or not the aforementioned processes are executed with respect to all of the matrices tmp_mt (Step S27).

When the aforementioned processes are not executed with respect to all of the matrices tmp_mt (Step S27: No), the convolution layer 10a shifts the process to Step S26. When the aforementioned processes are executed with respect to all of the matrices tmp_mt (Step S27: Yes), the convolution layer 10a outputs the error gradient diff1 (Step S28).

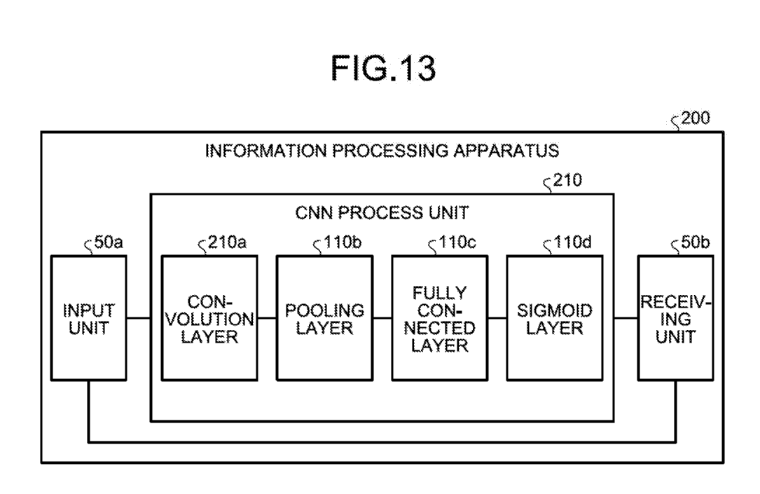

Next, a configuration of the information processing apparatus according to the second embodiment will be explained. FIG. 13 is a functional block diagram illustrating the configuration of the information processing apparatus according to the second embodiment. As illustrated in FIG. 13, this information processing apparatus 200 includes the input unit 50a, the receiving unit 50b, and a CNN process unit 210.

Explanation of the input unit 50a and the receiving unit 50b is similar to that of the input unit 50a and the receiving unit 50b illustrated in FIG. 4, and thus the explanation thereof is omitted here.

The CNN process unit 210 is a processing unit that reflects the error gradient between the correct answer information and the answer of the network when the image data is input in order to perform the learning of the network so that the correct answer can be universally developed. The CNN process unit 210 includes a convolution layer 210a, the pooling layer 110b, the fully connected layer 110c, and the sigmoid layer 110d. The CNN process unit 210 may correspond to an integrated device such as an ASIC and a FPGA. The CNN process unit 210 may correspond to an electronic circuit such as a CPU and a MPU.

In the learning of the network performed by the CNN process unit 210, there exist two phases of the normal and the reverse propagations, and the normal and the reverse propagations are repeatedly executed.

A process of the normal propagation to be executed by the CNN process unit 210 will be explained. When receiving an input of the image data in the normal propagation, the CNN process unit 210 performs a convolution operation by using the kernels in the convolution layer 210a, and extracts feature amounts from the input image data. The extracted feature amounts are input to the fully connected layer 110c by the pooling layer 110b after the execution of Average-pooling. The fully connected layer 110c converts the feature amounts into the feature amount vectors. The feature amount vectors are converted into the probability vectors by the sigmoid layer 110d.

A process in the reverse propagation to be executed by the CNN process unit 210 will be explained. The CNN process unit 210 acquires, from the receiving unit 50b, information on the error gradient between the probability vectors and the correct answer information, and propagates the error gradient in the network in reverse to the normal propagation. Each of the convolution layer 210a, the fully connected layer 110c, and the sigmoid layer 110d computes the corresponding error gradient to be sent to the next layer thereof in the reverse direction, and further computes the weight gradient using correct weight such that the corresponding layer obtains the correct answer.

Herein, because a method of the CNN process unit 210 for computing the error gradient diff1 in the convolution layer 210a according to the second embodiment differs from that of the conventional CNN, the process for computing the error gradient diff1 executed by the convolution layer 210a will be explained.

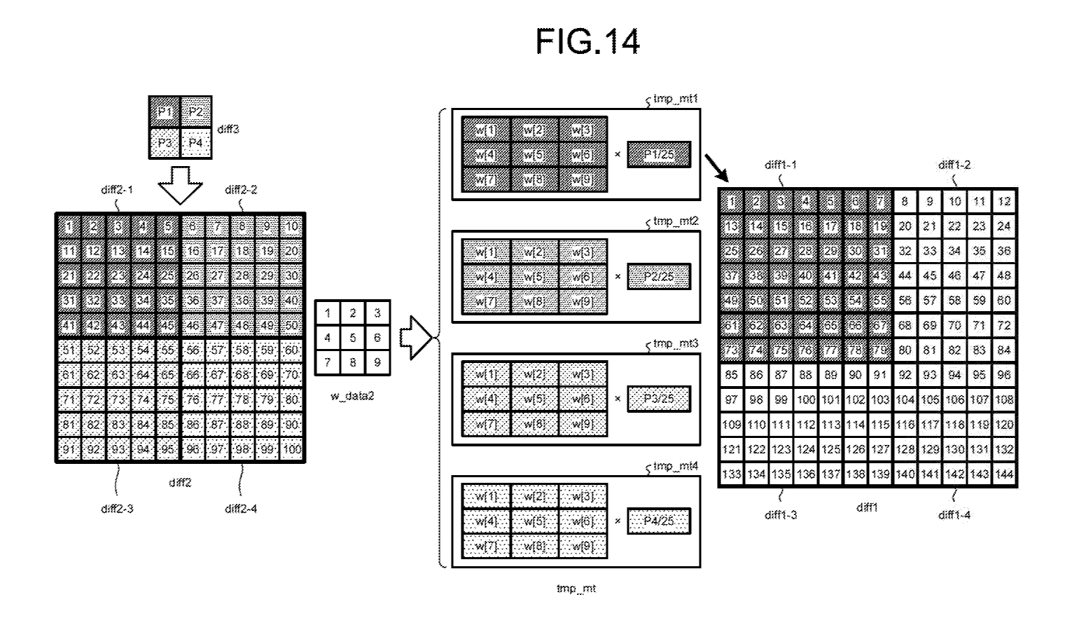

FIG. 14 is a diagram illustrating the process of the convolution layer according to the second embodiment. Numerical values of the error gradients diff1 and diff2 illustrated in FIG. 14 are indexes. The error gradient diff3 is an error gradient that is acquired by the pooling layer 110b from the upper layer. The pooling layer 110b expands the error gradient diff3 to obtain the error gradient diff2 (10×10) similarly to the pooling layer 10d illustrated in FIG. 1. For example, the pooling layer 110b expands the elements P1, P2, P3, and P4 to obtain respective diff2-1, diff2-2, diff2-3, and diff2-4 that are 5×5 areas. In Average-pooling of the reverse propagation, values, which are obtained by dividing values of the elements P1, P2, P3, and P4 by 25, are stored in the respective areas diff2-1, diff2-2, diff2-3, and diff2-4.

For this reason, all of the index values of the area diff2-1 are the same. By this characteristics, all of the matrices obtained by multiplying the values of the weight w_data2 by the value diff2[i] (i=1 to 5, 11 to 15, 21 to 25, 31 to 35, 41 to 45) become the same. For example, all of these matrices become the same as those obtained by performing scalar multiplication, by P1/25, on the values of the weight w_data2. Hereinafter, the matrix obtained by performing scalar multiplication on the values of the weight w_data2 by P1/25 will be referred to “matrix tmp_mt1”.

All of the index values of the area diff2-2 are the same. By this characteristics, all of the matrices obtained by multiplying the values of the weight w_data2 by the value diff2[i] (i=6 to 10, 16 to 20, 26 to 30, 36 to 40, 46 to 50) become the same. For example, all of these matrices become the same as those obtained by performing scalar multiplication, by P2/25, on the values of the weight w_data2. Hereinafter, the matrix obtained by performing scalar multiplication on the values of the weight w_data2 by P2/25 will be referred to “matrix tmp_mt2”.

All of the index values of the area diff2-3 are the same. By this characteristics, all of the matrices obtained by multiplying the values of the weight w_data2 by the value diff2[i] (i=51 to 55, 61 to 65, 71 to 75, 81 to 85, 91 to 95) become the same. For example, all of these matrices become the same as those obtained by performing scalar multiplication, by P3/25, on the values of the weight w_data2. Hereinafter, the matrix obtained by performing scalar multiplication on the values of the weight w_data2 by P3/25 will be referred to “matrix tmp_mt3”.

All of the index values of the area diff2-4 are the same. By the characteristics, all of the matrices obtained by multiplying the values of the weight w_data2 by the value diff2[i] (i=56 to 60, 66 to 70, 76 to 80, 86 to 90, 96 to 100) become the same. For example, all of these matrices become the same as those obtained by performing scalar multiplication on the values of the weight w_data2 by P4/25. Hereinafter, the matrix obtained by performing scalar multiplication on the values of the weight w_data2 by P4/25 will be referred to as “matrix tmp_mt4”.

Herein, the convolution layer 210a repeatedly executes a process for adding the values of the matrix tmp_mt1 to the area diff1-1 by the size of the weight w_data2. The upper-left end index of the area diff1-1 is “1”, and the lower-right end index thereof is “79”. Let the size of the weight w_data2 be “3×3”, the process is executed by a 3×3 window in the area diff1-1. All of the initial index values in the error gradient diff1 are zero.

First, the convolution layer 210a sets the 3×3 window at the indexes 1 to 3, 13 to 15, and 25 to 27 of the area diff1-1 to execute the following process. The convolution layer 210a updates the value of the index 1 in the area diff1-1 by using the value obtained by adding the value of “w[1]×P1/25” to the value of the index 1 in the area diff1-1. Subsequently, the convolution layer 210a updates the value of the index 2 in the area diff1-1 by using the value obtained by adding the value of “w[2]×P1/25” to the value of the index 2 in the area diff1-1. The convolution layer 210a similarly updates the values of the indexes 3, 13 to 15, and 25 to 27.

The convolution layer 210a sets the 3×3 window at the indexes 2 to 4, 14 to 16, and 26 to 28 of the area diff1-1 to execute the following process. The convolution layer 210a updates the value of the index 2 in the area diff1-1 by using the value obtained by adding the value of “w[1]×P1/25” to the value of the index 2 in the area diff1-1. Subsequently, the convolution layer 210a updates the value of the index 3 in the area diff1-1 by using the value obtained by adding the value of “w[2]×P1/25” to the value of the index 3 in the area diff1-1. The convolution layer 210a similarly updates the values of the indexes 4, 14 to 16, and 26 to 28.

The convolution layer 210a updates the index values of the area diff1-1 while shifting the window one by one by the aforementioned procedure. The number of the elements in the error gradient diff2 is 25, and thus the convolution layer 210a shifts the window one by one to repeat the index updating process 25 times.

Similarly to the aforementioned process for the addition to the area diff1-1, the convolution layer 210a repeatedly executes the process for adding the values of the matrix tmp_mt2 to the area diff1-2 by the size of the weight w_data2. The upper-left end index of the area diff1-2 is “6”, and the lower-right end index thereof is “84”.

Similarly to the aforementioned process for the addition to the area diff1-1, the convolution layer 210a repeatedly executes the process for adding the values of the matrix tmp_mt3 to the area diff1-3 by the size of the weight w_data2. The upper-left end index of the area diff1-3 is “61”, and the lower-right end index thereof is “139”.

Similarly to the aforementioned process for the addition to the area diff1-1, the convolution layer 210a repeatedly executes the process for adding the values of the matrix tmp_mt4 to the area diff1-4 by the size of the weight w_data2. The upper-left end index of the area diff1-4 is “66”, and the lower-right end index thereof is “144”.

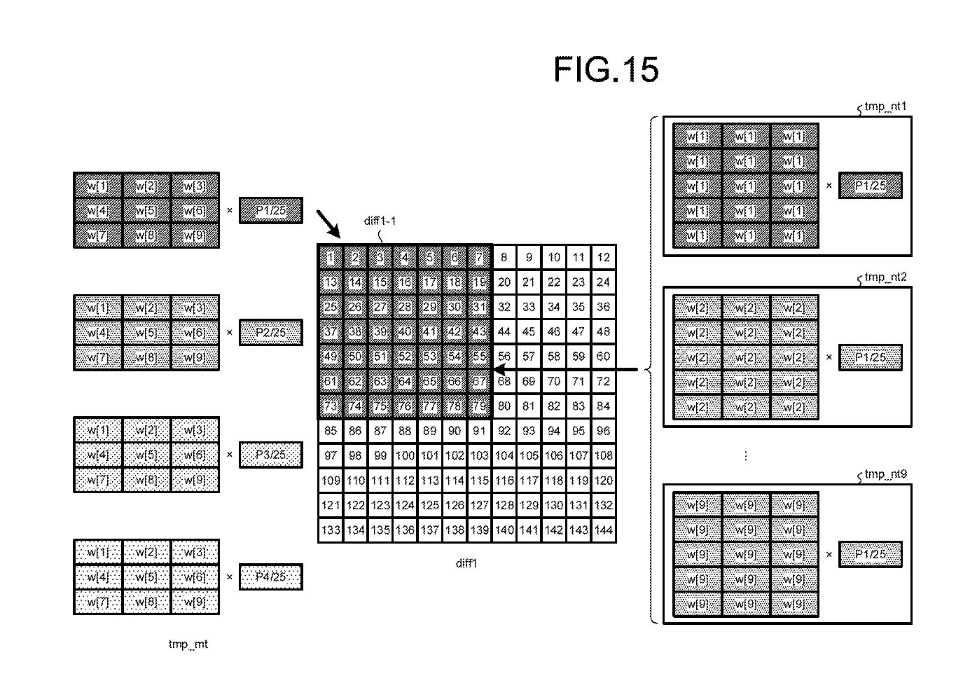

Meanwhile, the operation amount can be reduced by replacing the computation of the convolution layer 210a illustrated in FIG. 14 with a computation of totalizing a plurality of rectangular areas, each of which is constituted of elements having the same value. FIG. 15 is a diagram illustrating the process of the convolution layer according to the second embodiment. For example, in considering each of the elements of the area diff1-1 after totalizing the 3×3 matrices tmp_mt, the matrix of the area diff1-1 is equal to the matrix obtained by adding, to the area diff1-1, 5×5 matrices corresponding to the number of the elements of the weight w_data2, each of which is constituted of elements having the same value.

In other words, in the process illustrated in FIG. 14, the “25” 3×3 matrices tmp_mt1 are totalized when computing each of the element (index) values of the area diff1-1. On the other hand, as illustrated in FIG. 15, the aforementioned process can be converted into a process for totalizing the “9” 5×3 matrices.

The 5×3 matrices are the matrices tmp_nt1 to tmp_nt9. In FIG. 15, the illustration of the matrices tmp_nt3 to tmp_nt8 is omitted. The value obtained by performing scalar multiplication on the value w[1] by the value P1/25 is set to each of the elements in the matrix mp_nt1. The value obtained by performing scalar multiplication on the value w[2] by the value P1/25 is set to each of the elements in the matrix mp_nt2. The value obtained by performing scalar multiplication on the value w[3] by the value P1/25 is set to each of the elements in the matrix mp_nt3. The value obtained by performing scalar multiplication on the value w[4] by the value P1/25 is set to each of the elements in the matrix mp_nt4. The value obtained by performing scalar multiplication on the value w[5] by the value P1/25 is set to each of the elements in the matrix mp_nt5. The value obtained by performing scalar multiplication on the value w[6] by the value P1/25 is set to each of the elements in the matrix mp_nt6. The value obtained by performing scalar multiplication on the value w[7] by the value P1/25 is set to each of the elements in the matrix mp_nt7. The value obtained by performing scalar multiplication on the value w[8] by the value P1/25 is set to each of the elements in the matrix mp_nt8. The value obtained by performing scalar multiplication on the value w[9] by the value P1/25 is set to each of the elements in the matrix mp_nt9.

When computing the element values of the area diff1-1 by using the 5×3 matrices tmp_nt1 to tmp_nt9, the convolution layer 210a generates and uses a rectangular difference table to compute the element values of the area diff1-1.

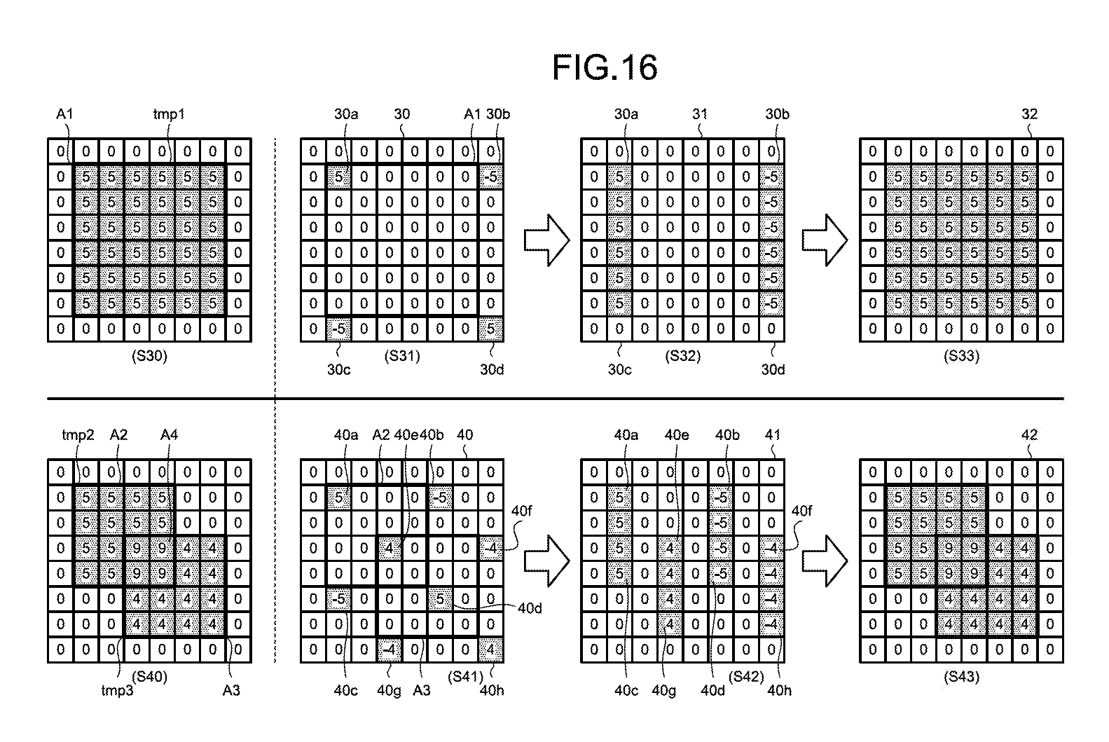

FIG. 16 is a diagram illustrating the rectangular difference table. For example, as illustrated in Step S30, let a matrix to be added to an area A1 be a matrix tmp1, and all of the values to be set to the matrix tmp1 be the same, namely “5”. When the matrix tmp1 is added to the area A1, “5” is set to all of the elements in the area A1. The convolution layer 210a computes this result by using a rectangular difference table 30 to be mentioned later.

The convolution layer 210a generates the rectangular difference table 30 on the basis of the relation between this matrix tmp1 and the area A1 to which this matrix tmp1 is added (Step S31).

For example, the convolution layer 210a specifies positions of respective elements 30a to 30d in the rectangular difference table. For example, the element 30a is an element existing at an upper-left end cell of the area A1. The element 30b is an element existing at a next right cell of an upper-right end cell of the area A1. The element 30c is an element existing at a next under cell of a lower-left end cell of the area A1. The element 30d is an element existing at a diagonally under cell of a lower-right end cell of the area A1. The convolution layer 210a sets the value “5” at the elements 30a and 30d, and sets the value “−5” at the element 30b and 30c to generate the rectangular difference table 30. Values of elements other than the elements 30a to 30d are zero.

The convolution layer 210a performs cumulative addition on the rectangular difference table 30 in a longitudinal direction to compute a table 31 (Step S32). The convolution layer 210a performs cumulative addition on the table 31 in a lateral direction to compute a table 32 (Step S33). The element values of the table 32 correspond to those obtained by adding the matrix tmp1 to the area A1.

Subsequently, as illustrated in Step S40, let a matrix to be added to the area A2 be a matrix tmp2, and all of the values to be set to the matrix tmp2 be “5”. Let a matrix to be added to the area A3 be a matrix tmp3, and all of the values to be set to the matrix tmp2 be “4”. Addition of the matrix tmp2 to the area A2 and addition of the matrix tmp3 to the area A3 set “5” in the area A2, set “4” in the area A3, and set “9” in the area A4 where the area A2 and the area A3 overlap with each other. The convolution layer 210a computes this result by using a rectangular difference table 40 to be mentioned later.

For example, the convolution layer 210a specifies positions of elements 40a to 40h of the rectangular difference table. For example, the element 40a is an element existing at an upper-left end cell of the area A2. The element 40b is an element existing at a next right cell of an upper-right end cell of the area A2. The element 40c is an element existing at a next under cell of a lower-left end cell of the area A2. The element 40d is an element existing at a diagonally under cell of a lower-right end cell of the area A2.

The element 40e is an element existing at an upper-left end cell of the area A3. The element 40f is an element existing at a next right cell of an upper-right end cell of the area A3. The element 40g is an element existing at a next under cell of a lower-left end cell of the area A3. The element 40h is an element existing at a diagonally under cell of a lower-right end cell of the area A3.

The convolution layer 210a sets the value “5” at the elements 40a and 40d, and sets the value “−5” at the element 40b and 40c. The convolution layer 210a sets the value “4” at the elements 40e and 40e, and further sets the value “−4” at the element 40f and 40g. Thus, the convolution layer 210a sets the values at the elements 40a to 40h, and further sets the value “0” at the other elements to generate the rectangular difference table 40.

The convolution layer 210a executes the cumulative addition on the rectangular difference table 40 in a longitudinal direction to compute a table 41 (Step S42). The convolution layer 210a executes the cumulative addition on the table 41 in a lateral direction to compute a table 42 (Step S43). The element values of the table 42 correspond to those obtained by adding the matrix tmp2 to the area A2 and further adding the matrix tmp3 to the area A3.

The convolution layer 210a adds the matrices tmp_nt1 to tmp_nt9 to the area diff1-1 by using the rectangular difference table 40 illustrated in FIG. 16. The convolution layer 210a generates a rectangular difference table rect_diff on the basis of the relation between the values of the matrices and the respective areas on which the matrices are arranged.

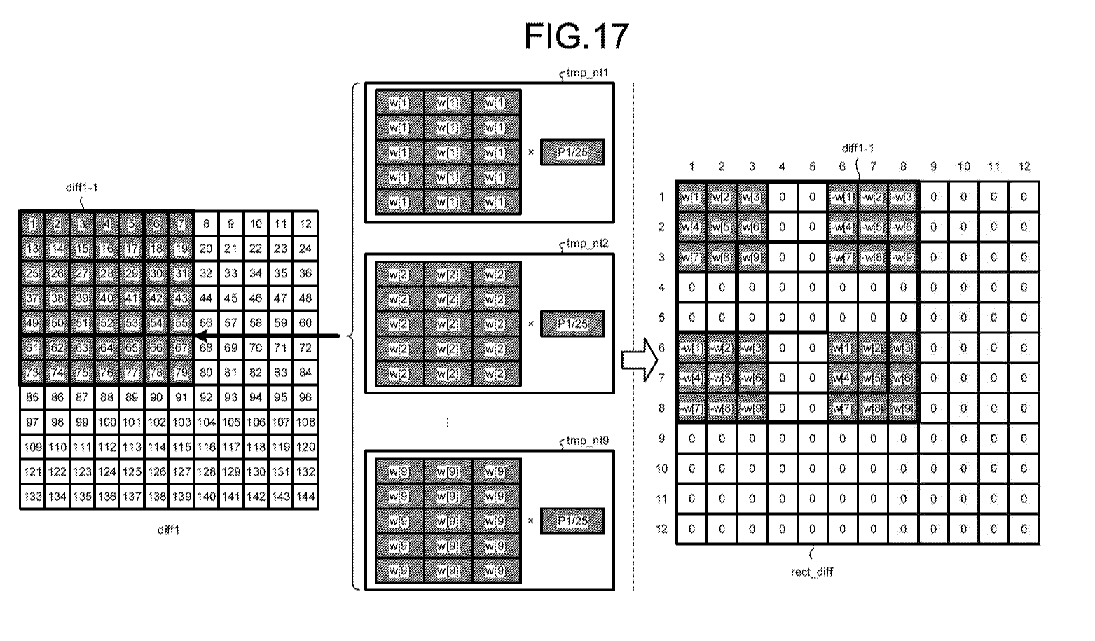

FIG. 17 is a diagram illustrating one example of the rectangular difference table generated by the convolution layer according to the second embodiment. An area of the error gradient diff, on which the matrices are added, is expressed by “R, L”. “R” indicates an upper-left end index of the area. “L” indicates a lower-right end index of the area. The element existing in the u-th row and v-th column from the left top of the rectangular difference table rect_diff is expressed as the element “u, v”.

The values of a matrix tmp_nt1 is added to the respective elements of the area “1, 53”. Therefore, the convolution layer 210a sets the value w[1] at the elements “1, 1” and “6, 6”, and sets the value −w[1] at the elements “1, 6” and “6, 1”.

The values of a matrix tmp_nt2 is added to the respective elements of the area “2, 54”. Therefore, the convolution layer 210a sets the value w[2] at the elements “1, 2” and “6, 7”, and sets the value −w[2] at the elements “1, 7” and “6, 2”.

The values of a matrix tmp_nt3 is added to the respective elements of the area “3, 55”. Therefore, the convolution layer 210a sets the value w[3] at the elements “1, 3” and “6, 8”, and sets the value −w[3] at the elements “1, 8” and “6, 3”.

The values of a matrix tmp_nt4 is added to the respective elements of the area “13, 65”. Therefore, the convolution layer 210a sets the value w[4] at the elements “2, 1” and “7, 6”, and sets the value −w[4] at the elements “2, 6” and “7, 1”.

The values of a matrix tmp_nt5 is added to the respective elements of the area “14, 66”. Therefore, the convolution layer 210a sets the value w[5] at the elements “2, 2” and “7, 7”, and sets the value −w[5] at the elements “2, 7” and “7, 2”.

The values of a matrix tmp_nt6 is added to the respective elements of the area “15, 67”. Therefore, the convolution layer 210a sets the value w[6] at the elements “2, 3” and “7, 8”, and sets the value −w[6] at the elements “2, 8” and “7, 3”.

The values of a matrix tmp_nt7 is added to the respective elements of the area “25, 77”. Therefore, the convolution layer 210a sets the value w[7] at the elements “3, 1” and “8, 6”, and sets the value −w[7] at the elements “3, 6” and “8, 1”.

The values of a matrix tmp_nt8 is added to the respective elements of the area “26, 78”. Therefore, the convolution layer 210a sets the value w[8] at the elements “3, 2” and “8, 7”, and sets the value −w[8] at the elements “3, 7” and “8, 2”.

The values of a matrix tmp_nt9 is added to the respective elements of the area “27, 79”. Therefore, the convolution layer 210a sets the value w[9] at the elements “3, 3” and “8, 8”, and sets the value −w[9] at the elements “3, 8” and “8, 3”.

The convolution layer 210a executes the aforementioned process to generate the rectangular difference table rect_diff for computing the area diff1-1. For the convenience of explanation, the case is explained here, in which the rectangular difference table rect_diff for computing the area diff1-1 is generated, the rectangular difference tables for computing the areas diff1-2 to diff4 are generated similarly to the area diff1-1. The convolution layer 210a performs cumulative addition on the rectangular difference table rect_diff in the longitudinal and lateral directions, so that it is possible to compute the area diff1-1. The computation result of the error gradient diff1 obtained by using the rectangular difference table rect_diff is similar to that explained with reference to FIG. 14, however, use of the rectangular difference table rect_diff enables to reduce the operation amount.

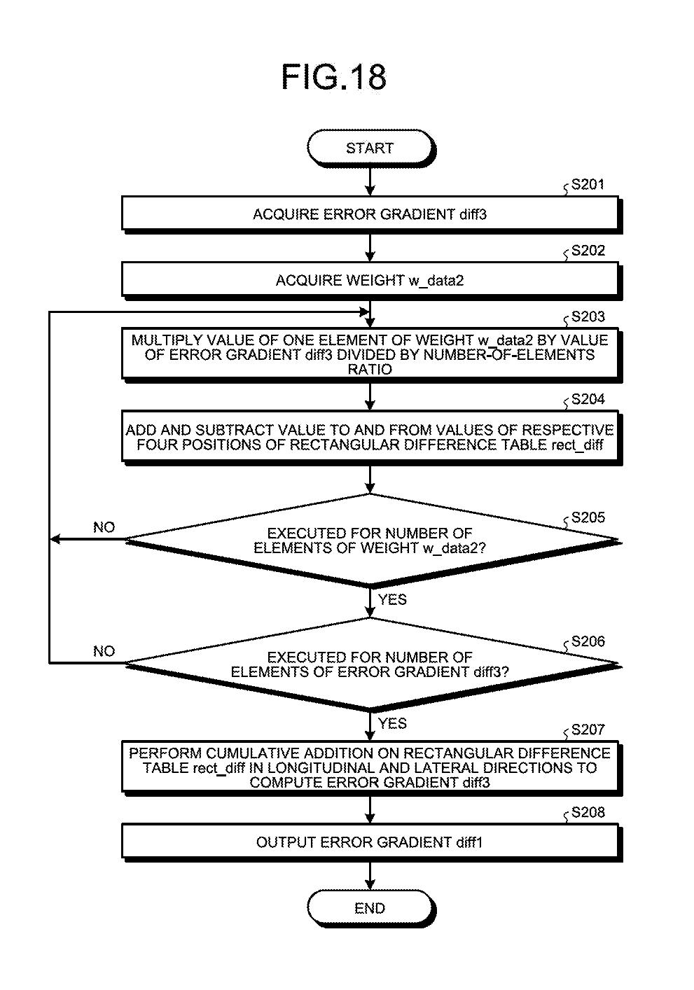

Next, a processing procedure of the information processing apparatus according to the second embodiment will be explained. FIG. 18 is a flowchart illustrating the processing procedure of the information processing apparatus according to the second embodiment. As illustrated in FIG. 18, the pooling layer 110b of the information processing apparatus 200 acquires the error gradient diff3 (Step S201). The convolution layer 210a of the information processing apparatus 200 acquires the weight (kernel) w_data2 (Step S202).

The convolution layer 210a multiplies the value of one element of the weight w_data2 by the value of the error gradient diff3 divided by the number-of-elements ratio (Step S203). The convolution layer 210a adds and subtracts the value to and from the values of respective four positions of the rectangular difference table rect_diff (Step S204).

The convolution layer 210a determines whether or not Steps S203 and S204 are executed for the number of the elements of the weight w_data2 (Step S205). When Steps S203 and S204 are not executed for the number of the elements of the weight w_data2 (Step S205: No), the convolution layer 210a shifts the process to Step S203. On the other hand, when Steps S203 and S204 are executed for the number of the elements of the weight w_data2 (Step S205: Yes), the convolution layer 210a shifts the process to Step S206.

The convolution layer 210a determines whether or not Steps S203 to S205 are executed for the number of the elements of the error gradient diff3 (Step S206). When Steps S203 to S205 are not executed for the number of the elements of the error gradient diff3 (Step S206: No), the convolution layer 210a shifts the process to S203. On the other hand, when Steps S203 to S205 are executed for the number of the elements of the error gradient diff3 (Step S206: Yes), the convolution layer 210a shifts the process to Step S207.

The convolution layer 210a performs the cumulative addition on the rectangular difference table rect_diff in the longitudinal and the lateral directions to compute the error gradient diff3 (Step S207). The convolution layer 210a outputs the error gradient diff1 (Step S208).

Next, effects of the information processing apparatus 200 according to the second embodiment will be explained. When computing the error gradient diff1 to be output to the lower layer in the reverse propagation process, the convolution layer 210a of the information processing apparatus 200 replaces the conventional computation with the computation of totalizing a plurality of rectangular areas, each of which is constituted of elements having the same value, so that it is possible to reduce the operation amount.

For example, the conventional computation is a computation, as illustrated in FIG. 11, in which “100” 3×3 matrices tmp_mt as the weight (kernel) are totalized while shifting the “100” 3×3 matrices tmp_mt on the target area one by one. On the other hand, the convolution layer 210a generates the matrices corresponding to the number of the elements included in the weight, each of which is constituted of elements having the same value as each of the element values of the kernel, and updates the values of the matrices in accordance with the value of each the elements of the error gradient diff3. The convolution layer 210a arranges the plurality of matrices on the target area while shifting the matrices one by one, and totalizes, for each of elements in the target area, the values of the element of the arranged matrices located at the same position of the corresponding element to compute the values of the elements included in the target area.

When arranging the plurality of matrices while shifting the matrices one by one, the convolution layer 210a generates the rectangular difference table in accordance with the positions of the respective matrices. The convolution layer 210a performs the cumulative addition on the rectangular difference table in the longitudinal and the lateral directions to compute the element values of the target area. For this reason, the operation amount can be reduced compared with the process adding the matrices while shifting the matrices one by one.

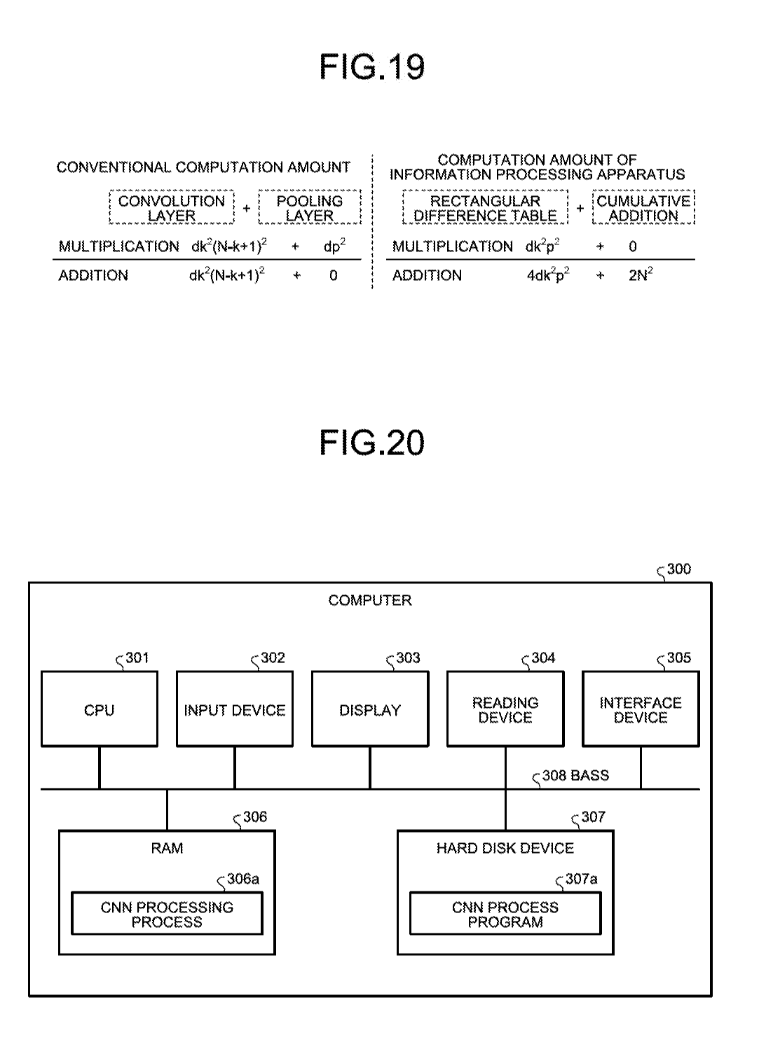

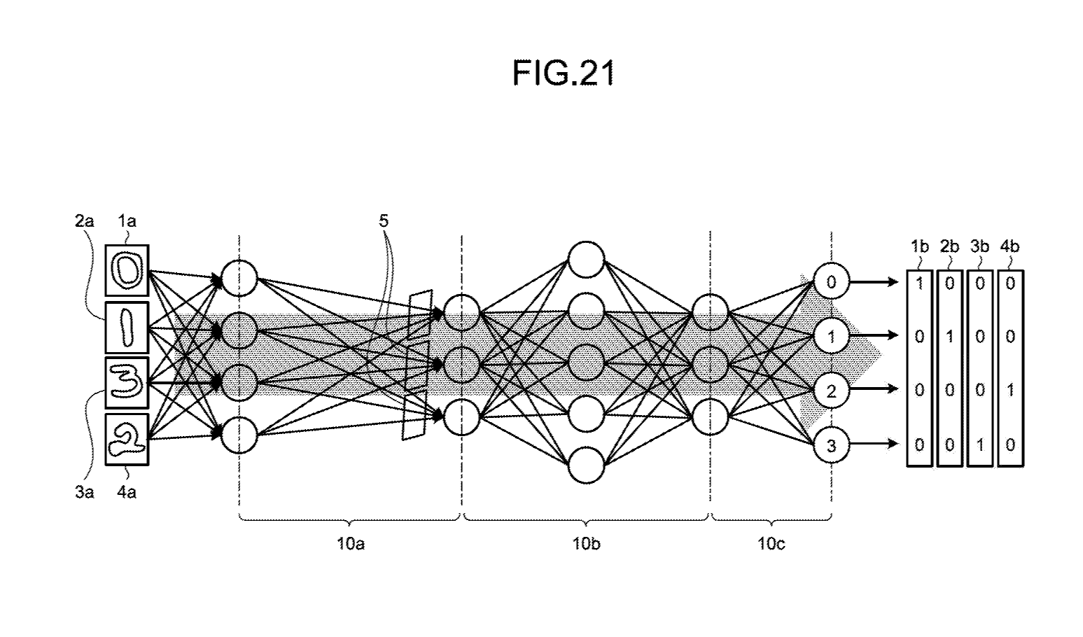

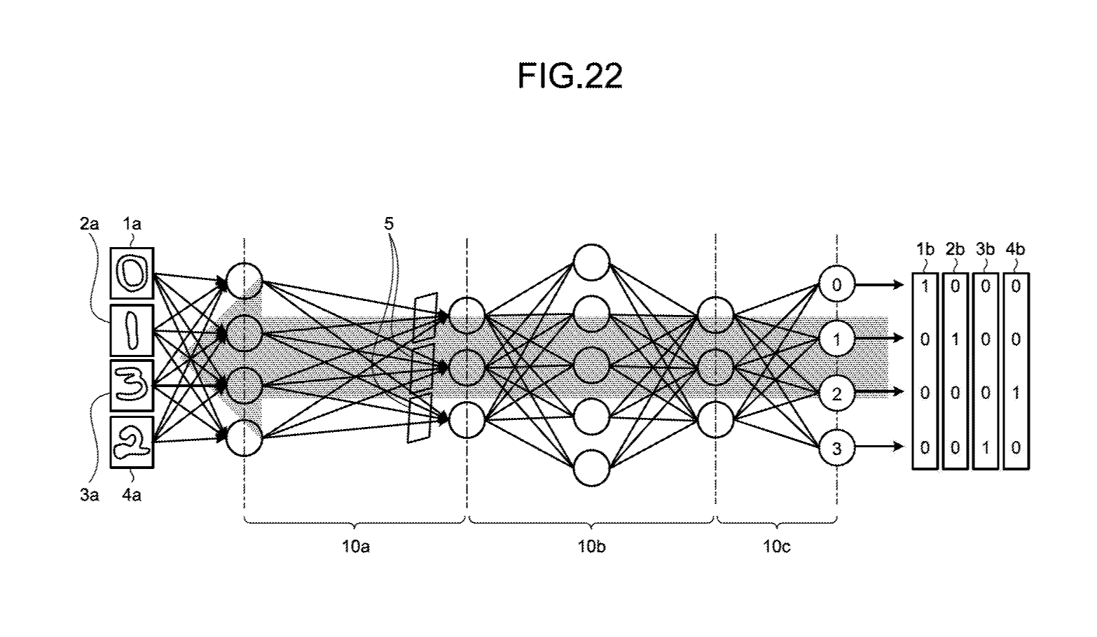

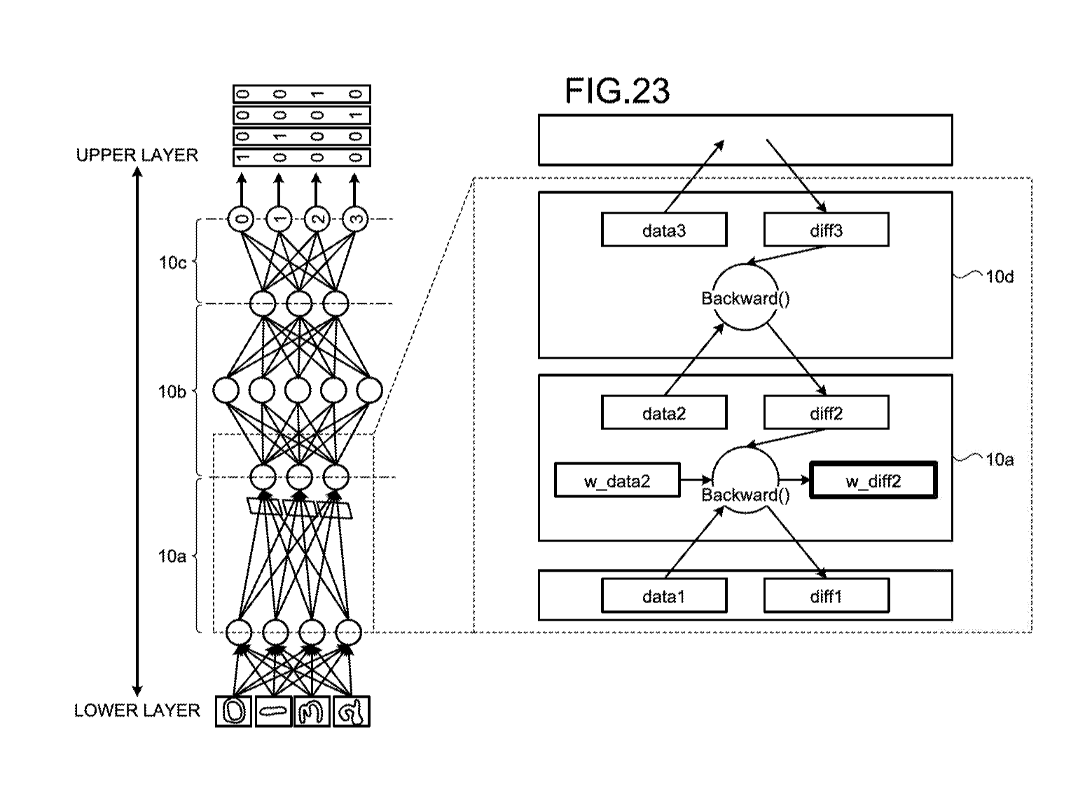

FIG. 19 is a diagram illustrating computation amounts for deriving the error gradient diff1. The computation amount of the conventional technology is “dk² (N−k+1)²+dp²” with respect to the multiplication part, and is, “dk² (N−k+1)²” with respect to the addition part. On the other hand, the computation amount of the information processing apparatus 200 according to the second embodiment is “dk²p²” with respect to the multiplication part, and is “4dk²p²+2N²” with respect to the addition part. Herein, let the size of the error gradient diff1 be “N×N”, the size of the weight w_data2 be “k×k”, the size of the error gradient diff3 be “p×p”, and the number of the kernels be “d”. The large/small relation between the symbols is “N>>p and N>>k”. For this reason, an influence to be given to the computation amount by the value “N” is large, and thus it is found that the computation amount of the conventional technology is larger than that of the information processing apparatus 200.

Meanwhile, the process of the convolution layer 110a according to the aforementioned first embodiment and the process of the convolution layer 210a according to the second embodiment are explained separately, however, not limited thereto. For example, a convolution layer that performs processes of both the convolution layers 110a and 210a may be provided in each of the CNN process units 110 and 210.

Next, a hardware configuration example of the information processing apparatus 100 according to the aforementioned embodiments will be explained. FIG. 20 is a diagram illustrating the hardware configuration example of the information processing apparatus.

As illustrated in FIG. 20, a computer 300 includes a CPU 301 that executes various computation processes, an input device 302 that receives an input of data from a user, and a display 303. The computer 300 includes a reading device 304 that reads a program and the like from a memory medium, and an interface device 305 that performs the input and output of data to and from another computer through a network. The computer 300 includes a RAM 306 that temporarily memorizes various kinds of information and a hard disk device 307. Each of the devices 301 to 307 is connected with a bus 308.

The hard disk device 307 includes a CNN process program 307a. The CPU 301 reads the CNN process program 307a and expands the program in the RAM 306. The CNN process program 307a functions as a CNN processing process 306a. For example, processes of the CNN processing process 306a correspond to the processes of the CNN process units 110 and 210.

The CNN process program 307a is not needed to be previously memorized in the hard disk device 307. For example, the programs may be memorized in a “portable physical medium” such as a Flexible Disk (FD), a Compact Disc-Read Only Memory (CD-ROM), a Digital Versatile Disc (DVD), a magnet-optical disk, and an Integrated Circuit card (IC card), which are inserted into the computer 300, and the computer 300 may read therefrom and execute the CNN process program 307a.

According to an aspect of the embodiments, the operation amount in the convolution layer can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus including:
a processor that executes a process comprising:
acquiring, in a pooling layer, information on an error gradient including a plurality of elements from an upper layer, when computing a learning value of a learning network including a plurality of layers;
performing, in a convolution layer, cumulative additions on a plurality of elements included in the information in a lateral direction and a longitudinal direction to convert the information into an integrated image, when acquiring information from a lower layer;
specifying, in the convolution layer, an area corresponding to the one element among from a plurality of elements included in the integrated image, when computing a value of one element included in a weight gradient;
dividing, in the convolution layer, the specified area having elements into a plurality of partial areas;
first computing, in the convolution layer, total values of elements included in the respective partial areas based on characteristics of the integrated image;
second computing, in the convolution layer, for each of the partial areas, a value based on the one or more total values of the elements included in the one or more partial areas and a value of one of the elements of the error gradient corresponding to the corresponding partial area; and
totalizing, in the convolution layer, the computed values to execute a process for computing the value of the one element.

2. The information processing apparatus according to claim 1, wherein, the first computing extracts values of first, second, third, and fourth elements based on the partial areas, and subtracts an added value of the second and third elements from an added value of the first and fourth elements to compute one of the total values.

3. A non-transitory computer readable storage medium having stored therein a program that causes a computer to execute a process including:
acquiring, in a pooling layer, information on an error gradient including a plurality of elements from an upper layer, when computing a learning value of a learning network including a plurality of layers;
performing, in a convolution layer, cumulative additions on a plurality of elements included in the information in a lateral direction and a longitudinal direction to convert the information into an integrated image, when acquiring information from a lower layer;
specifying, in the convolution layer, an area corresponding to the one element among from a plurality of elements included in the integrated image, when computing a value of one element included in a weight gradient;
dividing, in the convolution layer, the specified area having elements into a plurality of partial areas;
first computing, in the convolution layer, total values of elements included in the respective partial areas based on characteristics of the integrated image;
second computing, in the convolution layer, for each of the partial areas, a value based on the one or more total values of the elements included in the one or more partial areas and a value of one of the elements of the error gradient corresponding to the corresponding partial area; and
totalizing, in the convolution layer, the computed values to execute a process for computing the value of the one element.

4. The non-transitory computer readable storage medium according to claim 3, wherein the first computing extracts values of first, second, third, and fourth elements based on the partial areas, and subtracts an added value of the second and third elements from an added value of the first and fourth elements to compute one of the total values.

5. A learning-network learning value computing method, comprising:
acquiring, in a pooling layer, information on an error gradient including a plurality of elements from an upper layer, when computing a learning value of a learning network including a plurality of layers, using a processor;
performing, in a convolution layer, cumulative additions on a plurality of elements included in the information in a lateral direction and a longitudinal direction to convert the information into an integrated image, when acquiring information from a lower layer, using the processor;
specifying, in the convolution layer, an area corresponding to the one element among from a plurality of elements included in the integrated image, when computing a value of one element included in a weight gradient, using the processor;
dividing, in the convolution layer, the specified area having elements into a plurality of partial areas, using the processor;
first computing, in the convolution layer, total values of elements included in the respective partial areas based on characteristics of the integrated image, using the processor;
second computing, in the convolution layer, for each of the partial areas, a value based on the one or more total values of the elements included in the one or more partial areas and a value of one of the elements of the error gradient corresponding to the corresponding partial area, using the processor; and
totalizing, in the convolution layer, the computed values to execute a process for computing the value of the one element, using the processor.

6. The learning-network learning value computing method according to claim 5, wherein the first computing extracts values of first, second, third, and fourth elements based on the partial areas, and subtracts an added value of the second and third elements from an added value of the first and fourth elements to compute one of the total values.
